(19) United States
(12) Patent Application Publication
(10) Pub. No.: US 2026/0268074 A1
(43) Pub. Date: Sep. 10, 2026

(54) AI AGENTIC WORKFLOW CONTROLLER

(71) Applicant: SAP SE, Walldorf (DE)

(72) Inventor: Srinivasa Byaiah Ramachandra Reddy, Bangalore (IN)

(21) Appl. No.: 19/072,494

(22) Filed: Mar. 6, 2025

(51) Int. Cl. G06F 40/20; G06F 21/62; G06Q 10/0631; H04L 51/216

(52) U.S. Cl. CPC G06F 40/20; G06F 21/629; G06Q 10/06316; H04L 51/216

(57) ABSTRACT

As discussed herein, a generative AI (GenAI) tool is improved by using multiple LLMs, at least one of which is allowed to access tools that provide additional information to improve the quality of results. The output from a first LLM is provided as part of a prompt to a second LLM for review. If the second LLM rejects the results provided by the first LLM, a revised prompt for the first LLM is generated. This process is repeated until the second LLM approves a response by the first LLM. The functionality of the GenAI tool may also be expanded by allowing it to respond to a user query with a sequence of scenarios instead of a single scenario.

### TECHNICAL FIELD

The subject matter disclosed herein generally relates to computer-implemented systems and methods for controlling workflow execution in distributed computing environments, and more specifically, to technical improvements in computer system operation through automated scenario selection and validation using cascaded large language models (LLMs).

### BACKGROUND

Existing computer systems that implement generative artificial intelligence (AI) face technical challenges in reliably controlling workflow execution. Current systems that use neural networks to generate output often produce unreliable or invalid results when processing user inputs. This leads to inefficient use of computing resources and degraded system performance.

### BRIEF DESCRIPTION OF THE DRAWINGS

FIG. 1 shows a network diagram illustrating an example network environment suitable for enhancing user interactions with applications by using generative AI as an AI agentic workflow controller.

FIG. 2 shows a block diagram of an application server, suitable for providing an AI agentic workflow controller.

FIG. 3 is a block diagram of a neural network, suitable for use as an AI agentic workflow controller, according to some example embodiments.

FIG. 4 illustrates a data flow for a generative AI being used as an AI agentic workflow controller, according to some example embodiments.

FIG. 5 illustrates an example database schema, suitable for use by an AI agentic workflow controller.

FIG. 6 illustrates a flowchart for a method of an AI agentic workflow controller, according to some example embodiments.

FIG. 7 shows a block diagram showing one example of a software architecture for a computing device.

FIG. 8 shows a block diagram of a machine in the example form of a computer system within which instructions may be executed for causing the machine to perform any one or more of the methodologies discussed herein.

### DETAILED DESCRIPTION

Example computer-implemented methods and systems are directed to technical improvements in workflow control through a unified generative AI (GenAI) validation architecture that coordinates multiple software products. The system implements specialized validation capabilities through deployed scenario definitions. The system provides enhanced control through multiple conversational processing patterns including navigational control patterns, transactional processing patterns, and information retrieval patterns. Navigational patterns optimize system resource allocation for functionality routing. Transactional patterns improve processing efficiency for task completion. Information patterns enhance accuracy of data retrieval operations.

While existing systems may route user prompts directly to an LLM, such approaches lead to technical problems including non-responsive outputs and processing errors (“hallucinations”). Direct routing fails to properly validate and optimize system responses.

The technical solution described herein improves computer system operation by implementing a multi-stage validation architecture. The system enables controlled access to auxiliary processing tools that provide supplemental data to enhance result quality. Additionally, the system implements a cascaded validation process where initial LLM output is analyzed by a second LLM stage. If the validation stage rejects the results, the system automatically generates revised prompts for reprocessing. This iterative optimization continues until the validation stage approves the response.

The system's capabilities are further enhanced through intelligent decomposition of complex queries into optimized processing sequences rather than single-stage execution. For example, when processing a query requiring data transfer between system A and system B, the architecture automatically identifies subtasks, determines appropriate processing scenarios, executes the scenarios in an optimized sequence, and generates a validated response.

The technical improvements described herein enhance the functioning of computer systems implementing generative AI by optimizing scenario identification accuracy and improving processing result quality. In some implementations, the system achieves performance comparable to more computationally intensive models while using reduced computing resources through its multi-stage validation architecture.

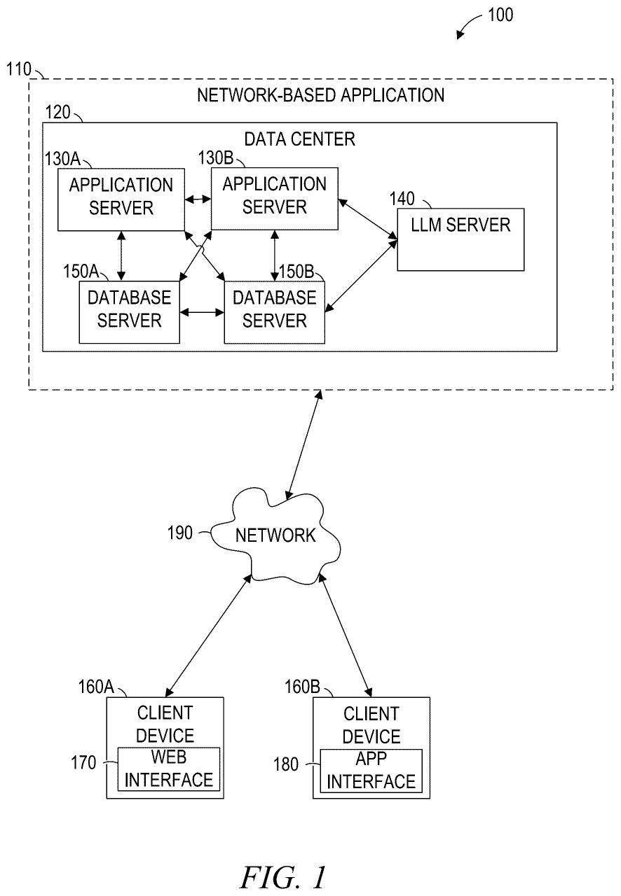

FIG. 1 shows a network diagram illustrating an example network environment 100 suitable for enhancing user interactions with applications by using generative AI as an AI agentic workflow controller. The network environment 100 includes a network-based application 110, client devices 160A and 160B, and a network 190. The network-based application is implemented at a data center 120 that comprises application servers 130A and 130B in communication with database servers 150A and 150B and an LLM server 140. The letter suffixes of reference numbers may be omitted when doing so does not raise ambiguity. For example, the client devices 160A-160B may be referred to collectively as “client devices 160.” Similarly, when the specific one of the client devices 160A-160B is not of particular import, “client device 160” may be referenced.

An application executing on the application servers 130A or 130B may access data from the database servers 150A and 150B. The network-based application 110 may provide a user interface that allows a user to store or retrieve data from the database servers 150. The user interface may be provided to the user via a web interface 170 (e.g., by generating a hypertext markup language [HTML] page at the server and sending it to a web browser to render on a display device) or an application interface 180 (e.g., by sending data via an application programming interface [API] for processing by an application executing on the client device 160). As described herein, a user may provide a natural language prompt instead of interacting with a traditional user interface. The application server 130A generates, based on the user-provided prompt, a prompt for an LLM provided by the LLM server 140. The generated prompt is provided to the LLM server 140, which selects a scenario for execution to generate a response to the user. The application server 130 executes the selected scenario and provides a response to the user.

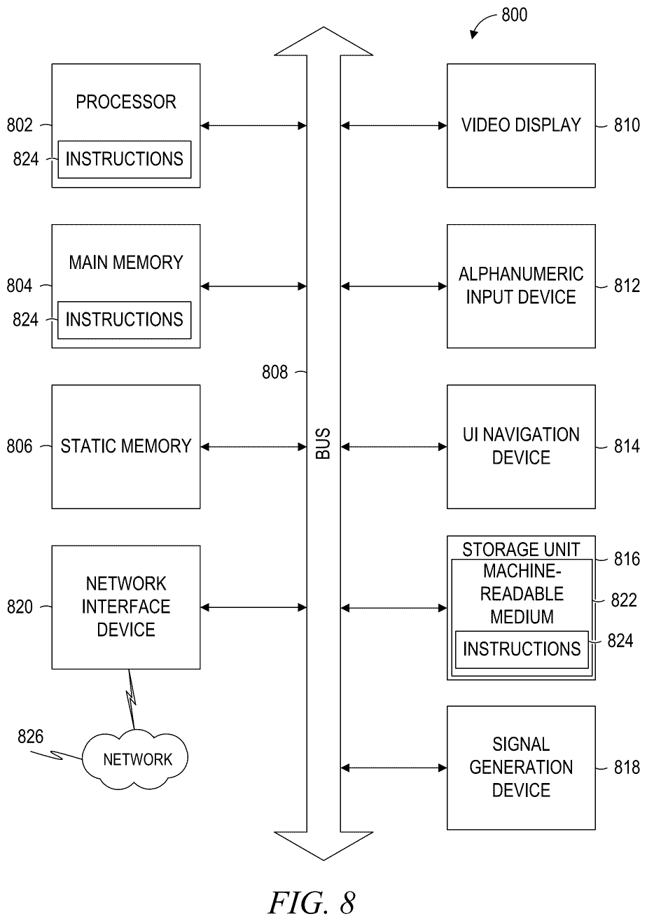

The application servers 130A-130B, the database servers 150A-150B, and the client devices 160A-160B may each be implemented in a computer system, in whole or in part, as described below with respect to FIG. 8. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 8. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 130A-130B, the database servers 150A-150B, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one LLM server 140, two application servers 130A-130B, two client devices 160A and 160B, and the like), any number of each element is contemplated. For example, the application server 130A may be one of dozens or hundreds of active and standby servers and provide services to millions of client devices. Likewise, the LLM server 140 may be used by many application servers 130, and so on.

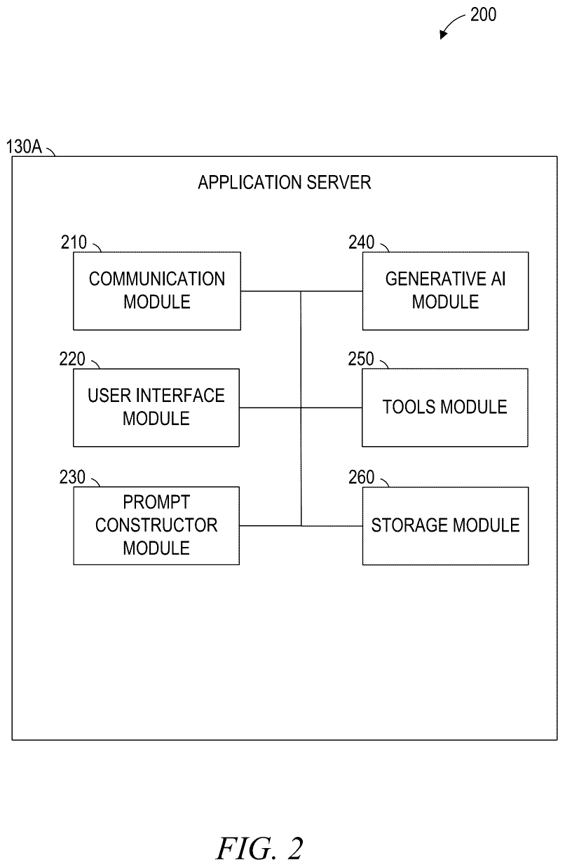

FIG. 2 shows a block diagram 200 of the application server 130A, suitable for providing an AI agentic workflow controller. The application server 130A is shown as including a communication module 210, a user interface module 220, a prompt constructor module 230, a generative AI module 240, a tools module 250, and a storage module 260, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 130A and transmits data from the application server 130A. For example, the communication module 210 may receive, from the client device 160A, selections or input into fields of a user interface generated by the user interface module 220. The input may include a natural language prompt.

The user interface module 220 generates user interfaces for display on a display device of the client devices 160. For example, an HTML document may be generated and sent, via the communication module 210, to the client device 160A for rendering by a web browser.

The prompt constructor module 230 constructs a prompt for an LLM based on a prompt provided by a user via a user interface generated by the user interface module 220. The constructed prompt may further be based on scenario data accessed from a database, historical interaction data with the user, or any suitable combination thereof.

The generative AI module 240 includes an LLM that generates a response to a prompt generated by the prompt constructor module 230. Using well-constructed prompts, a general-purpose LLM may provide high quality results without specialized training. The generated response may be used by the application server 130A to control operations of the application. Based on the performed operations, the user interface module 220 may generate an updated user interface for provision to the client device 160 and display to a user.

The LLM of the generative AI module 240 may access tools provided by the tools module 250. Example tools include web search, document grounding, knowledge graphs, conversation memory, data models, user roles, and the like.

Data, metadata, documents, instructions, or any suitable combination thereof may be stored and accessed by the storage module 260. For example, local storage of the application server 130A, such as a hard drive, may be used. As another example, network storage may be accessed by the storage module 260 via the network 190.

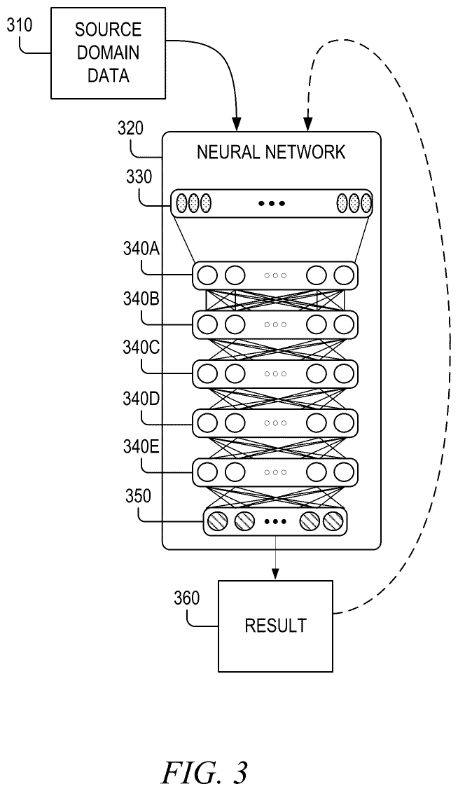

FIG. 3 is a block diagram of a neural network 320, suitable for use as an AI agentic workflow controller, according to some example embodiments. The neural network 320 takes source domain data 310 as input and processes the source domain data 310 using an input layer 330; intermediate, hidden layers 340A, 340B, 340C, 340D, and 340E; and output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset are used to train the model. Thus, the batch size ranges between one and the size of the training dataset, and the number of epochs is any positive integer value. The model parameters are updated after each batch (e.g., using gradient descent).

For self-supervised learning, the training dataset comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model, satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs-having reached a performance plateau-the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network (CNN), a recurrent neural network, a transformer neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input. Thus, the coefficients assign significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of nonlinear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In the training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a predetermined range, based on the known training images, backpropagation is used, where backpropagation is a common method of training artificial neural networks that are used with an optimization method such as a stochastic gradient descent (SGD) method.

Use of backpropagation can include propagation and weight updates. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value, which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision-tree learning, neural networks, DNNs, genetic or evolutionary algorithms, and the like. With the help of natural language processing (NLP) and advanced data preprocessing, a machine learning model (e.g., the neural network 320) can be trained on historical (existing) data (for instance, resource usage data) from the system to predict future data.

The transformer architecture processes an entire input at once rather than sequentially. For example, a recurrent neural network (RNN) processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating artificial intelligence, and the like) being provided as an input for determination of the next result.

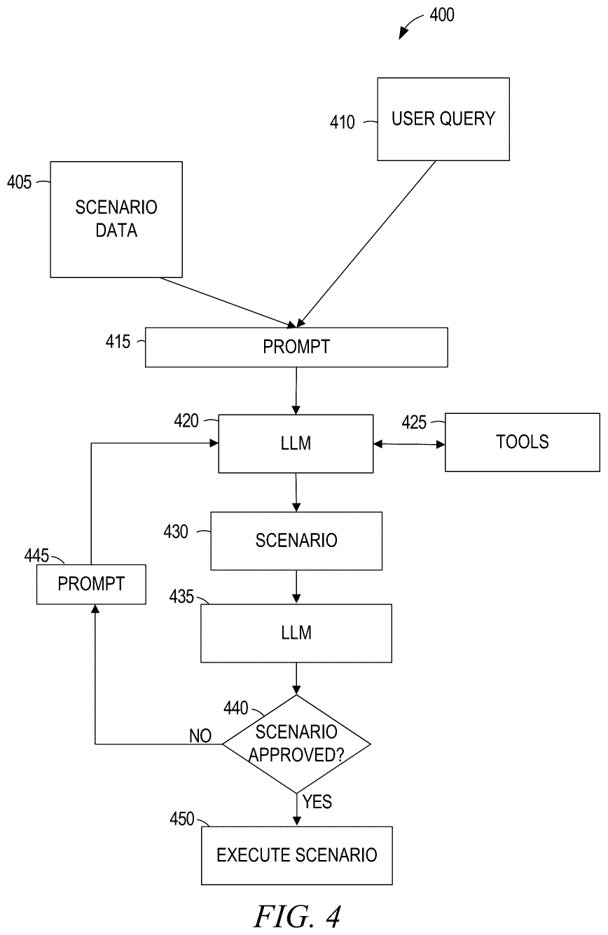

FIG. 4 illustrates a data flow 400 for a generative AI being used as an AI agentic workflow controller, according to some example embodiments. Data is used to generate a prompt 415. The data used includes scenario data 405, a user query 410, or any suitable combination thereof. The prompt 415 is provided to an LLM 420. In response to the prompt 415, the LLM 420 determines a scenario 430 that best addresses the user query 410.

To aid the LLM 420 in determining the scenario 430, the LLM 420 may access tools 425. The tools 425 may include a conversation history with the user to help the LLM 420 form responses that draw on a larger context than the user query 410, a document-grounding service that help the LLM 420 to avoid hallucinations, a knowledge graph that helps the LLM 420 to identify related concepts, external APIs (e.g., a web search API) that allow the LLM 420 to request additional information, or any suitable combination thereof.

In some example embodiments, the tools 425 allow the LLM 420 to determine the roles of the user that submitted the user query 410. Some or all of the scenarios may require a particular role. The user is only permitted to run a scenario 430 if the role is required by the scenario. Accordingly, the LLM 420 is enabled to ensure that the scenario 430 is a scenario that the user is permitted to run.

The scenario 430 generated by the LLM 420 may be considered an initial response. The scenario 430 is provided to the LLM 435 as part of a prompt that asks the LLM 435 to determine if the initial response is reasonable. If the LLM 435 rejects the scenario 430 (operation 440), a revised prompt 445 is generated and provided to the LLM 420. This process of determining the scenario 430 is repeated until the LLM 435 accepts the determined scenario.

Once the scenario 430 is approved, it is executed in operation 450. Output generated by the execution of the scenario 430 is provided to the user in response to the user query 410.

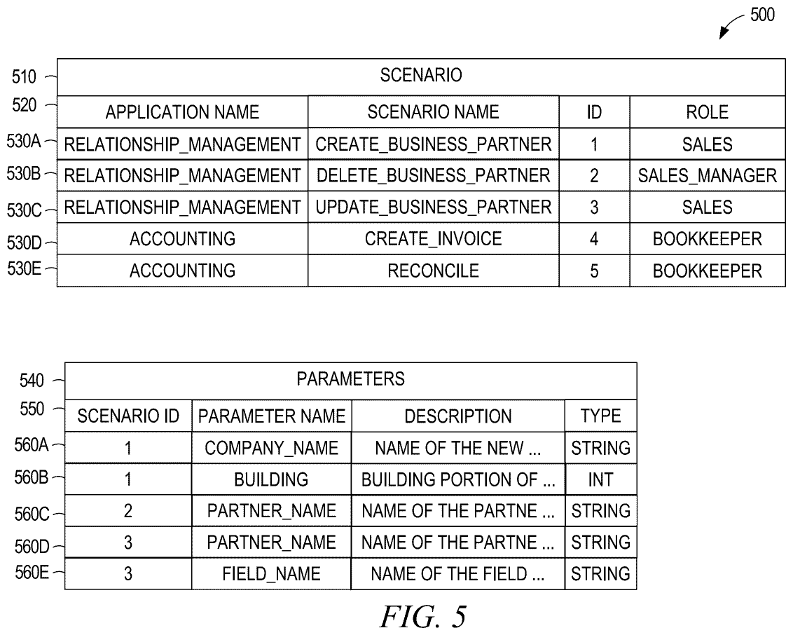

For example, data from the rows 530A-530C of FIG. 5 may be accessed to identify scenarios of a RELATIONSHIP_MANAGEMENT application. Additional data for the scenarios of the rows 530A-530C may be accessed from the parameters table 540 of FIG. 5. The data from the database schema 500 may be presented in an XML format, such as that shown below. To better illustrate a practical application, additional parameters that are not shown in FIG. 5 are included in the example XML portion below.

```
<scenarios>
  <scenario>
    <id>CREATE_BUSINESS_PARTNER</id>
    <description>Create a new business partner (BP).
</description>
    <parameters>
      <parameter>
        <id>COMPANY_NAME</id>
        <description>Company name only (without the
legal form).</description>
        <type>string</type>
      </parameter>
      <parameter>
        <id>CURRENCY_CODE</id>
        <description>Currency in code form (e.g., USD,
EUR). This parameter is typically derived from the
COUNTRY parameter (e.g., for Germany, the currency is
EUR).</description>
      </parameter>
      <parameter>
        <id>EMAIL_ADDRESS</id>
        <description>Email address. If the WEB_ADDRESS
parameter is not provided, you can derive it from the
email (with “www.”).</description>
      </parameter>
      <parameter>
        <id>WEB_ADDRESS</id>
        <description>Web address. If the web address is
not provided, you can derive it from the EMAIL_ADDRESS
(with “www.”).</description>
      </parameter>
      <parameter>
        <id>BP_ROLE</id>
        <description>Business Partner (BP) role.
Possible values are 01 (for customer) or 02 (for
supplier).
        </description>
      </parameter>
      <parameter>
        <id>STREET</id>
        <description>Street name.</description>
      </parameter>
      <parameter>
        <id>BUILDING</id>
        <description>Street or house
number.</description>
        <type>int</type>
      </parameter>
      <parameter>
        <id>POSTAL_CODE</id>
        <description>Postal/ZIP code.</description>
      </parameter>
      <parameter>
        <id>CITY</id>
        <description>City. If COUNTRY_CODE is not
provided, you can make an educated guess based on the
city.</description>
      </parameter>
      <parameter>
        <id>COUNTRY_CODE</id>
        <description>Country code (e.g., US for USA, DE
for Germany, GB for Great Britain). This parameter can
be used to derive the CURRENCY_CODE.</description>
      </parameter>
      <parameter>
        <id>PHONE_NUMBER</id>
        <description>Telephone number. If COUNTRY_CODE
is not provided, you can make an educated guess based on
the phone number.</description>
      </parameter>
      <parameter>
        <id>FAX_NUMBER</id>
        <description>Fax number.</description>
      </parameter>
    </parameters>
  </scenario>
  <scenario>
    <id>DELETE_BUSINESS_PARTNER</id>
    ...
  </scenario>
  ...
</scenarios>
```

The user may provide the user query 410 as a natural language prompt via a user interface. The user query 410 includes the user's specific request for a task to be performed. For example, the user query 410 may include particular details about an entity to be created or data being requested.

A prompt constructor (e.g., the prompt constructor module 230 of FIG. 2) uses some or all of the data to generate the prompt 415. The generated prompt is provided to the LLM 420. An example prompt 415 is below, with the body of the <scenarios> structure above replaced with ellipses.
You are tasked to translate user prompts into scenarios with parameters. Here is the mapping table of the scenarios in the form of an XML:
<scenarios>
. . .
</scenarios >
Analyze the user prompt to assign the correct scenarios and parameters. It is possible that your response contains more than one scenario. The same scenario can appear more than once. Each command may have 0 to n parameters.

Hi, we have a new customer, here are the details:
SAP KG
555 Main St.
69190 Walldorf
Telephone: +49/5555/5-55555
Fax: +49/5555/5-55556
info@sap.com

In the example above, everything before the line beginning with “Hi” is the system prompt. The portion of the prompt beginning with “Hi” is the user query 410. The system prompt includes, within the <scenarios></scenarios> block, information about the available scenarios, derived from the scenario data 405. The system prompt also includes additional instructions for the LLM 420. The LLM handles the user query 410 according to the instructions provided in the system prompt.

As instructed, in response to the prompt 415, the LLM 420 generates the scenario 430. An example output is shown below.

```
<SCENARIOS>
  <item>
    <NAME>CREATE_BUSINESS_PARTNER</NAME>
    <PARAMETERS>
      <item>
        <NAME>COMPANY_NAME</NAME>
        <VALUE>SAP</VALUE>
      </item>
      <item>
        <NAME>LEGAL_FORM</NAME>
        <VALUE>KG</VALUE>
      </item>
      <item>
        <NAME>EMAIL_ADDRESS</NAME>
        <VALUE>info@sap.com</VALUE>
      </item>
      <item>
        <NAME>BUILDING</NAME>
        <VALUE>555</VALUE>
      </item>
      <item>
        <NAME>POSTAL_CODE</NAME>
        <VALUE>69190</VALUE>
      </item>
      <item>
        <NAME>CITY</NAME>
        <VALUE>Walldorf</VALUE>
      </item>
      <item>
        <NAME>COUNTRY_CODE</NAME>
        <VALUE>DE</VALUE>
      </item>
      <item>
        <NAME>CURRENCY_CODE</NAME>
        <VALUE>EUR</VALUE>
      </item>
      <item>
        <NAME>PHONE_NUMBER</NAME>
        <VALUE>+49/5555/5-55555</VALUE>
      </item>
      <item>
        <NAME>FAX_NUMBER</NAME>
        <VALUE>+49/5555/5-55556</VALUE>
      </item>
    </PARAMETERS>
  </item>
</SCENARIOS>
```

In this example, the scenario CREATE_BUSINESS_PARTNER is performed with the indicated company_name, legal_form, email_address, building, postal_code, city, country_code, currency_code, phone_number, and fax_number parameters. Results from the scenario or scenarios are generated when the scenario is executed and a response to the user query 410 is generated and presented to the user.

In some example embodiments, instead of determining a single scenario 430, a scenario sequence of multiple scenarios is determined. In these example embodiments, the LLM 435 validates the scenario sequence. Once approved, the entire sequence of scenarios is executed to generate a response to the user query 410.

The user query 410 may be preprocessed by a planning module that breaks the user query 410 into a plurality of sub-tasks. The prompt 415 may be based on a first sub-task of the plurality of sub-tasks, and the remaining operations of FIG. 4 performed to generate a first result from the execution of the scenario in operation 450. Operations 415-450 may then be repeated by generating another prompt 415 for the LLM 420 based on a second sub-task of the plurality of sub-tasks, and so on until all sub-tasks are handled. Thus, the application server 130 receives, from the LLM 420, another scenario 430 for the second sub-task, generates another prompt for the LLM 435 based on the other scenario 430, generates another prompt to execute the approved scenario for the second sub-task, and provides a response to the user query 410 that is based on the output from the LLM for the additional approved scenario.

FIG. 5 illustrates an example database schema 500, suitable for use by an AI agentic workflow controller. The database schema 500 includes a scenario table 510 and a parameters table 540. The scenario table 510 includes rows 530A, 530B, 530C, 530D, and 530E of a format 520. The parameters table 540 includes rows 560A, 560B, 560C, 560D, and 560E of a format 550.

Each of the rows 530A-530E identifies an operation by associating a numeric identifier with a named scenario of a named application. Additionally, each of the rows 530A-530E includes a role that, in some example embodiments, is required for execution of the scenario. In the example of FIG. 5, the scenario table 510 defines three scenarios for the RELATIONSHIP_MANAGEMENT application and two scenarios for the ACCOUNTING application.

Using the role information, only a user with a SALES role can perform the scenarios of the rows 530A and 530C; only a user with a BOOKKEEPER role can perform the scenarios of the rows 530D and 530E; and only a user with a SALES_MANAGER role can perform the scenario of the row 530B. By way of example, only a few scenarios are shown for only a few applications. In practice, the scenarios table 510 may include data for dozens or hundreds of applications, and each application may have dozens or hundreds of scenarios.

The parameters table 540 contains metadata regarding the parameters of the scenarios identified in the scenario table 510. The scenario ID of the parameters table 540 can be cross-referenced with the ID of the scenario table 510 to access parameter metadata for a named scenario of an application. For example, the rows 560A and 560B contain metadata for the CREATE_BUSINESS_PARTNER scenario of the RELATIONSHIP_MANAGEMENT application by virtue of the matching ID values of one. Each of the rows 560A-560E includes a parameter name, a description of the parameter, and a type of the parameter (e.g., integer, string, double, long, float, array, or any suitable combination thereof).

In various example embodiments, more or fewer fields are stored in the scenario table 510 and the parameters table 540. For example, a default value may be stored for each parameter in the parameters table 540.

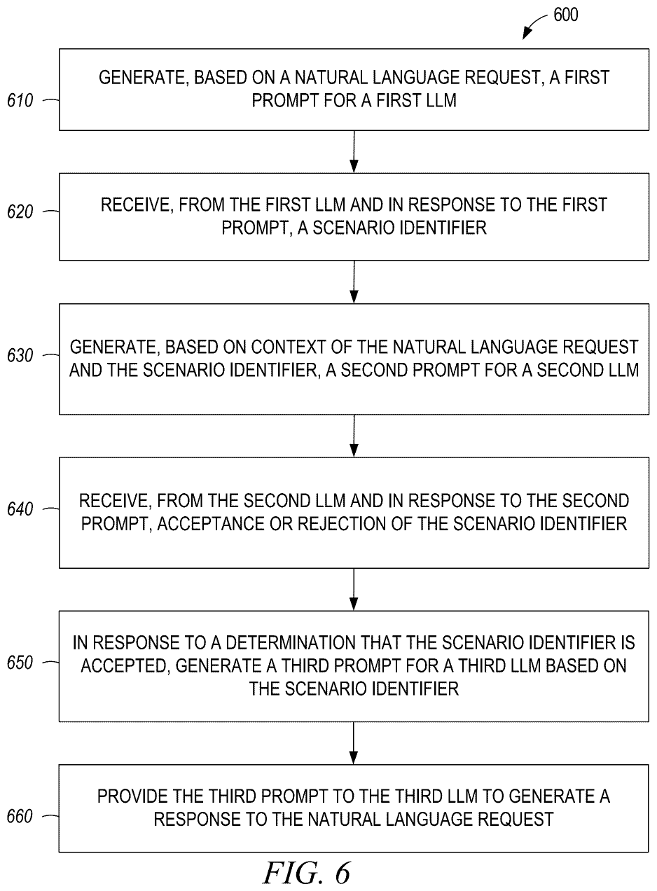

FIG. 6 illustrates a flowchart for a method 600 of an AI agentic workflow controller, according to some example embodiments. The method 600 includes operations 610, 620, 630, 640, 650, and 660. By way of example and not limitation, the method 600 is described as being performed by the application server 130 of FIG. 1, using the modules of FIG. 2, the machine learning model of FIG. 3, the data flow 400 of FIG. 4, and the database schema of FIG. 5.

The prompt constructor module 230, in operation 610, generates, based on a natural language request, a first prompt for a first LLM. The first prompt may include a system prompt portion and a user prompt portion. The system prompt portion is based, at least in part, on metadata for a scenario. The first prompt for the first LLM may be based on metadata for multiple scenarios. The user prompt portion is based, at least in part, on the natural language request (e.g., a natural language request received from a user via the user interface module 220). The system prompt portion may include instructions to the first LLM for a structured format to use to generate output.

The metadata for the scenario may include an identifier of the scenario, a description of the scenario, parameter metadata, or any suitable combination thereof. The parameter metadata may include, for each parameter of the scenario, a name of the parameter, a type of the parameter, a description of the parameter, or any suitable combination thereof. The first prompt for the LLM may be based on metadata for multiple scenarios.

In operation 620, the application server 130A receives, from the first LLM and in response to the first prompt, a scenario identifier. For example, the response to the prompt may include a numeric or text scenario identifier that corresponds to a scenario name or identifier in the scenario table 510.

The prompt constructor module 230, in operation 630, generates, based on context of the natural language request and the scenario identifier, a second prompt for a second LLM. The second prompt is based, at least in part, on context of the natural language request. For example, the second prompt may include a conversation history with the user. The second prompt asks the second LLM to determine if the output of the first LLM is reasonable.

In operation 640, the application server 130A receives, from the second LLM and in response to the second prompt, acceptance or rejection of the scenario identifier. The response from the second LLM may include an explanation of its reasoning. If the scenario identifier is rejected, another prompt for the first LLM may be generated and operations 620-640 repeated.

In response to a determination that the scenario identifier is accepted, the prompt constructor module 230 generates a third prompt for a third LLM based on the scenario identifier (operation 650). For example, a prompt in a database of prompts may be accessed using the scenario identifier. Thus, operation 650 may include accessing, from a database and based on the scenario identifier, text from the scenario table 510 or the parameters table 540 to include in the third prompt. Additional information for the scenario (e.g., parameters) may be determined based on output from the first LLM, information in the natural language request, or any suitable combination thereof. The third prompt may include the natural language request.

In operation 660, the application server 130A provides the third prompt to the third LLM to generate a response to the natural language request. The response to the natural language request is provided to the user. Thus, by the use of the method 600, a user is enabled to present a natural language request without specifying a particular scenario. Using the first and second LLMs, a scenario for the natural language request is identified and a customized prompt for the identified scenario is generated. As a result, the third LLM generates a result that is more likely to be helpful to the user, as compared to systems that simply provide the user's natural language request directly to the LLM.

Prior to performance of the method 600, the application server 130A may store data for all scenarios of an application into the scenario table 510 and the parameters table 540, both of FIG. 5. Accordingly, the generation of the prompts in operations 610, 630, and 650 may be based on the stored data from the database. Including a description of each parameter of each available scenario may assist the LLM in determining which scenario to invoke and the appropriate parameter values for the selected scenario.

In view of the above-described implementations of subject matter this application discloses the following list of examples. One feature of an example in isolation or more than one feature of an example, taken in combination and, optionally, in combination with one or more features of one or more further examples are further examples also falling within the disclosure of this application.

Example 1 is a system for recommending data assets, the system comprising: one or more hardware processors; and a memory that stores instructions that, when executed by the one or more hardware processors, cause the one or more hardware processors to perform operations comprising: generating, based on a natural language request, a first prompt for a first large language model (LLM); receiving, from the first LLM and in response to the first prompt, a scenario identifier; generating, based on context of the natural language request and the scenario identifier, a second prompt for a second LLM; receiving, from the second LLM and in response to the second prompt, acceptance or rejection of the scenario identifier; in response to a determination that the scenario identifier is accepted, generating a third prompt for a third LLM based on the scenario identifier; and providing the third prompt to the third LLM to generate a response to the natural language request.

In Example 2, the subject matter of Example 1, wherein the operations further comprise: accessing, from a database and based on the scenario identifier, text to include in the third prompt.

In Example 3, the subject matter of Examples 1-2, wherein the operations further comprise: receiving, via a user interface, the natural language request.

In Example 4, the subject matter of Examples 1-3, wherein the operations further comprise: in response to a determination that the scenario identifier is rejected, generating a fourth prompt for the first LLM based on the natural language request and output from the second LLM.

In Example 5, the subject matter of Examples 1-4, wherein the operations further comprise: accessing, by the first LLM, a conversation memory of communications with a user that provided the natural language request.

In Example 6, the subject matter of Examples 1-5, wherein the operations further comprise: determining, by the first LLM, whether a user that provided the natural language request has a role that is allowed to execute a scenario identified by the scenario identifier.

In Example 7, the subject matter of Examples 1-6, wherein the operations further comprise: breaking the natural language request into a plurality of sub-tasks including a first sub-task and a second sub-task, wherein the first prompt is based on the first sub-task; generating a fourth prompt for the first LLM based on the second sub-task; receiving, from the first LLM and in response to the fourth prompt, a second scenario identifier; and generating a fifth prompt for the third LLM based on the second scenario identifier; wherein the response to the natural language request is further generated by providing the fifth prompt to the third LLM.

Example 8 is a non-transitory computer-readable medium that stores instructions that, when executed by one or more processors, cause the one or more processors to perform operations comprising: generating, based on a natural language request, a first prompt for a first large language model (LLM); receiving, from the first LLM and in response to the first prompt, a scenario identifier; generating, based on context of the natural language request and the scenario identifier, a second prompt for a second LLM; receiving, from the second LLM and in response to the second prompt, acceptance or rejection of the scenario identifier; in response to a determination that the scenario identifier is accepted, generating a third prompt for a third LLM based on the scenario identifier; and providing the third prompt to the third LLM to generate a response to the natural language request.

In Example 9, the subject matter of Example 8, wherein the operations further comprise: accessing, from a database and based on the scenario identifier, text to include in the third prompt.

In Example 10, the subject matter of Examples 8-9, wherein the operations further comprise: receiving, via a user interface, the natural language request.

In Example 11, the subject matter of Examples 8-10, wherein the operations further comprise: in response to a determination that the scenario identifier is rejected, generating a fourth prompt for the first LLM based on the natural language request and output from the second LLM.

In Example 12, the subject matter of Examples 8-11, wherein the operations further comprise: accessing, by the first LLM, a conversation memory of communications with a user that provided the natural language request.

In Example 13, the subject matter of Examples 8-12, wherein the operations further comprise: determining, by the first LLM, whether a user that provided the natural language request has a role that is allowed to execute a scenario identified by the scenario identifier.

In Example 14, the subject matter of Examples 8-13, wherein the operations further comprise: breaking the natural language request into a plurality of sub-tasks including a first sub-task and a second sub-task, wherein the first prompt is based on the first sub-task; generating a fourth prompt for the first LLM based on the second sub-task; receiving, from the first LLM and in response to the fourth prompt, a second scenario identifier; and generating a fifth prompt for the third LLM based on the second scenario identifier; wherein the response to the natural language request is further generated by providing the fifth prompt to the third LLM.

Example 15 is a method comprising: generating, by one or more hardware processors and based on a natural language request, a first prompt for a first large language model (LLM); receiving, from the first LLM and in response to the first prompt, a scenario identifier; generating, based on context of the natural language request and the scenario identifier, a second prompt for a second LLM; receiving, from the second LLM and in response to the second prompt, acceptance or rejection of the scenario identifier; in response to a determination that the scenario identifier is accepted, generating a third prompt for a third LLM based on the scenario identifier; and providing the third prompt to the third LLM to generate a response to the natural language request.

In Example 16, the subject matter of Example 15 includes accessing, from a database and based on the scenario identifier, text to include in the third prompt.

In Example 17, the subject matter of Examples 15-16 includes receiving, via a user interface, the natural language request.

In Example 18, the subject matter of Examples 15-17 includes, in response to a determination that the scenario identifier is rejected, generating a fourth prompt for the first LLM based on the natural language request and output from the second LLM.

In Example 19, the subject matter of Examples 15-18 includes accessing, by the first LLM, a conversation memory of communications with a user that provided the natural language request.

In Example 20, the subject matter of Examples 15-19 includes determining, by the first LLM, whether a user that provided the natural language request has a role that is allowed to execute a scenario identified by the scenario identifier.

Example 21 is an apparatus comprising means to implement any of Examples 1-20.

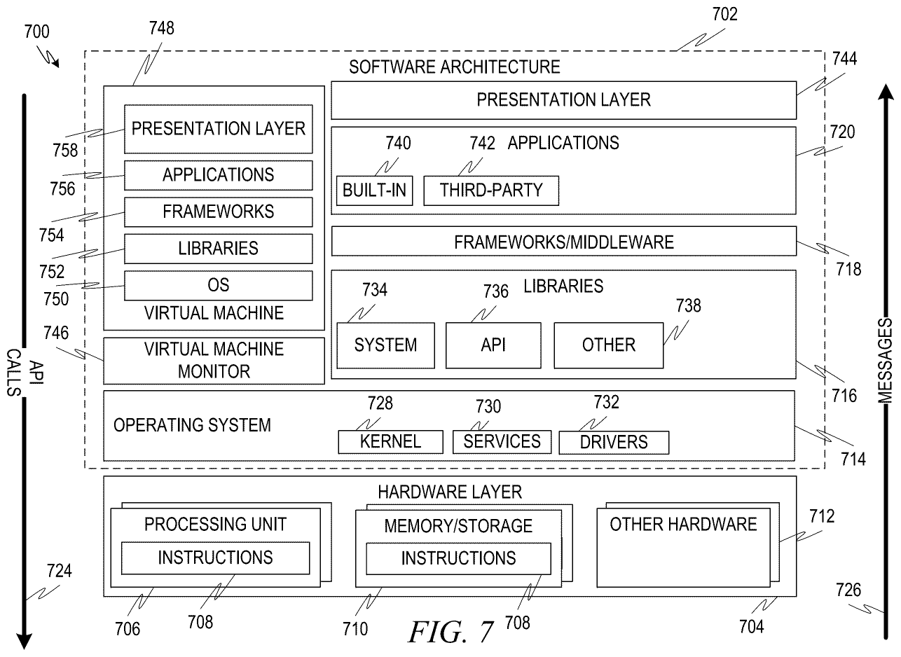

FIG. 7 shows a block diagram 700 showing one example of a software architecture 702 for a computing device. The software architecture 702 may be used in conjunction with various hardware architectures, for example, as described herein. FIG. 7 is merely a non-limiting example of a software architecture, and many other architectures may be implemented to facilitate the functionality described herein. A representative hardware layer 704 is illustrated and can represent, for example, any of the above referenced computing devices. In some examples, the hardware layer 704 may be implemented according to the architecture of the computer system of FIG. 7.

The representative hardware layer 704 comprises one or more processing units 706 having associated executable instructions 708. Executable instructions 708 represent the executable instructions of the software architecture 702, including implementation of the methods, modules, subsystems, and components, and so forth described herein and may also include memory and/or storage modules 710, which also have executable instructions 708. Hardware layer 704 may also comprise other hardware 712 which represents any other hardware of the hardware layer 704. Examples of the other hardware 712 include the hardware components shown in FIG. 8.

In the example architecture of FIG. 7, the software architecture 702 may be conceptualized as a stack of layers where each layer provides particular functionality. For example, the software architecture 702 may include layers such as an operating system 714, libraries 716, frameworks/middleware 718, applications 720, and presentation layer 744. Operationally, the applications 720 and/or other components within the layers may invoke API calls 724 through the software stack and access a response, returned values, and so forth illustrated as messages 726 in response to the API calls 724. The layers illustrated are representative in nature and not all software architectures have all layers. For example, some mobile or special purpose operating systems may not provide a frameworks/middleware 718 layer, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of an interrupt and, in response, cause the software architecture 702 to pause its current processing and execute an interrupt service routine (ISR) when an interrupt is accessed.

The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks/middleware 718 may provide a higher-level common infrastructure that may be utilized by the applications 720 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any of the built-in applications as well as a broad assortment of other applications. In a specific example, the third-party application 742 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 742 may invoke the API calls 724 provided by the mobile operating system such as operating system 714 to facilitate functionality described herein.

The applications 720 may utilize built-in operating system functions (e.g., kernel 728, services 730 and/or drivers 732), libraries (e.g., system libraries 734, API libraries 736, and other libraries 738), and frameworks/middleware 718 to create user interfaces to interact with users of the system. Alternatively, or additionally, in some systems, interactions with a user may occur through a presentation layer, such as presentation layer 744. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware computing device. A virtual machine is hosted by a host operating system (operating system 714) and typically, although not always, has a virtual machine monitor 746, which manages the operation of the virtual machine 748 as well as the interface with the host operating system (i.e., operating system 714). A software architecture executes within the virtual machine 748 such as an operating system 750, libraries 752, frameworks/middleware 754, applications 756 and/or presentation layer 758. These layers of software architecture executing within the virtual machine 748 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 8 shows a block diagram of a machine in the example form of a computer system 800 within which instructions 824 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit [CPU], a graphics processing unit [GPU], or both), a main memory 804, and a static memory 806, which communicate with each other via a bus 808. The computer system 800 may further include a video display unit 810 (e.g., a liquid crystal display [LCD] or a cathode ray tube [CRT]). The computer system 800 also includes an alphanumeric input device 812 (e.g., a keyboard or a touch-sensitive display screen), a user interface (UI) navigation (or cursor control) device 814 (e.g., a mouse), a storage unit 816, a signal generation device 818 (e.g., a speaker), and a network interface device 820.

### Machine-Readable Medium

The storage unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, with the main memory 804 and the processor 802 also constituting a machine-readable medium 822.

While the machine-readable medium 822 is shown in FIG. 8 to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with the instructions 824. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 824 may further be transmitted or received over a communications network 826 using a transmission medium. The instructions 824 may be transmitted using the network interface device 820 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system for recommending data assets, the system comprising:
one or more hardware processors; and
a memory that stores instructions that, when executed by the one or more hardware processors, cause the one or more hardware processors to perform operations comprising:
generating, based on a natural language request, a first prompt for a first large language model (LLM);
receiving, from the first LLM and in response to the first prompt, a scenario identifier;
generating, based on context of the natural language request and the scenario identifier, a second prompt for a second LLM;
receiving, from the second LLM and in response to the second prompt, acceptance or rejection of the scenario identifier;
in response to a determination that the scenario identifier is accepted, generating a third prompt for a third LLM based on the scenario identifier; and
providing the third prompt to the third LLM to generate a response to the natural language request.

2. The system of claim 1, wherein the operations further comprise:
accessing, from a database and based on the scenario identifier, text to include in the third prompt.

3. The system of claim 1, wherein the operations further comprise:
receiving, via a user interface, the natural language request.

4. The system of claim 1, wherein the operations further comprise:
in response to a determination that the scenario identifier is rejected, generating a fourth prompt for the first LLM based on the natural language request and output from the second LLM.

5. The system of claim 1, wherein the operations further comprise:
accessing, by the first LLM, a conversation memory of communications with a user that provided the natural language request.

6. The system of claim 1, wherein the operations further comprise:
determining, by the first LLM, whether a user that provided the natural language request has a role that is allowed to execute a scenario identified by the scenario identifier.

7. The system of claim 1, wherein the operations further comprise:
breaking the natural language request into a plurality of sub-tasks including a first sub-task and a second sub-task, wherein the first prompt is based on the first sub-task;
generating a fourth prompt for the first LLM based on the second sub-task;
receiving, from the first LLM and in response to the fourth prompt, a second scenario identifier; and
generating a fifth prompt for the third LLM based on the second scenario identifier;
wherein the response to the natural language request is further generated by providing the fifth prompt to the third LLM.

8. A non-transitory computer-readable medium that stores instructions that, when executed by one or more processors, cause the one or more processors to perform operations comprising:
generating, based on a natural language request, a first prompt for a first large language model (LLM);
receiving, from the first LLM and in response to the first prompt, a scenario identifier;
generating, based on context of the natural language request and the scenario identifier, a second prompt for a second LLM;
receiving, from the second LLM and in response to the second prompt, acceptance or rejection of the scenario identifier;
in response to a determination that the scenario identifier is accepted, generating a third prompt for a third LLM based on the scenario identifier; and
providing the third prompt to the third LLM to generate a response to the natural language request.

9. The non-transitory computer-readable medium of claim 8, wherein the operations further comprise:
accessing, from a database and based on the scenario identifier, text to include in the third prompt.

10. The non-transitory computer-readable medium of claim 8, wherein the operations further comprise:
receiving, via a user interface, the natural language request.

11. The non-transitory computer-readable medium of claim 8, wherein the operations further comprise:
in response to a determination that the scenario identifier is rejected, generating a fourth prompt for the first LLM based on the natural language request and output from the second LLM.

12. The non-transitory computer-readable medium of claim 8, wherein the operations further comprise:
accessing, by the first LLM, a conversation memory of communications with a user that provided the natural language request.

13. The non-transitory computer-readable medium of claim 8, wherein the operations further comprise:
determining, by the first LLM, whether a user that provided the natural language request has a role that is allowed to execute a scenario identified by the scenario identifier.

14. The non-transitory computer-readable medium of claim 8, wherein the operations further comprise:
breaking the natural language request into a plurality of sub-tasks including a first sub-task and a second sub-task, wherein the first prompt is based on the first sub-task;
generating a fourth prompt for the first LLM based on the second sub-task;
receiving, from the first LLM and in response to the fourth prompt, a second scenario identifier; and
generating a fifth prompt for the third LLM based on the second scenario identifier;
wherein the response to the natural language request is further generated by providing the fifth prompt to the third LLM.

15. A method comprising:
generating, by one or more hardware processors and based on a natural language request, a first prompt for a first large language model (LLM);
receiving, from the first LLM and in response to the first prompt, a scenario identifier;
generating, based on context of the natural language request and the scenario identifier, a second prompt for a second LLM;
receiving, from the second LLM and in response to the second prompt, acceptance or rejection of the scenario identifier;
in response to a determination that the scenario identifier is accepted, generating a third prompt for a third LLM based on the scenario identifier; and
providing the third prompt to the third LLM to generate a response to the natural language request.

16. The method of claim 15, further comprising:
accessing, from a database and based on the scenario identifier, text to include in the third prompt.

17. The method of claim 15, further comprising:
receiving, via a user interface, the natural language request.

18. The method of claim 15, further comprising:
in response to a determination that the scenario identifier is rejected, generating a fourth prompt for the first LLM based on the natural language request and output from the second LLM.

19. The method of claim 15, further comprising:
accessing, by the first LLM, a conversation memory of communications with a user that provided the natural language request.

20. The method of claim 15, further comprising:
determining, by the first LLM, whether a user that provided the natural language request has a role that is allowed to execute a scenario identified by the scenario identifier.
